(19) United States
(12) Patent Application Publication
(10) Pub. No.: US 2006/0128414 A1
(43) Pub. Date: Jun. 15, 2006

(54) Wireless communication systems

(75) Inventors: Masaaki Shida, Hachioji (JP); Kei Suzuki, Kokubunji (JP); Mikio Kuwahara, Hachioji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/295,582

(22) Filed: Dec. 7, 2005

(30) Foreign Application Priority Data
Dec. 13, 2004 (JP) 2004-359314

(51) Int. Cl. H04B 7/00

(52) U.S. Cl. 455/522

(57) ABSTRACT

In a wireless communication system having a base station and a terminal, it is important to extend the operating life of the terminal in the case of using a battery as the power supply of the terminal. Particularly in the case where a state in which a base station is not present in the range within which the terminal can communicate lasts long, the reduction of the electric power consumption during the standby of the terminal becomes an issue. The terminal monitors the received signal power strength of a signal transmitted by the base station. When the power strength exceeds a prescribed value, it is considered that the base station is present and the base station performs operations for carrying out communication with the base station.

### INCORPORATION BY REFERENCE

The present application claims priority from Japanese application JP 2004-359,314 filed on Dec. 13, 2004, the content of which is hereby incorporated by reference into this application.

### BACKGROUND OF THE INVENTION

1. Field of the Invention

The present invention is an invention which is concerned with a wireless communication system comprising a base station and a terminal and which pertains in particular to the configuration, and the control method therefor, of the wireless part of a terminal for implementing the attainment of power savings during the standby of the terminal.

2. Description of the Related Art

When it comes to conventional wireless communication systems, there exist e.g. systems such as sensor nets and RF-ID (Radio Frequency Identification) tags (refer to: “Sensor Networks: Evolution, Opportunities, and Challenges”, Proceedings of the IEEE, Vol. 91, No. 8 (August 2003), pp. 1247-1256). Below, an explanation regarding conventional wireless communication systems called sensor nets and RF-ID tags will be given by FIG. 1, FIG. 2, FIG. 3, and FIG. 4.

FIG. 1 is a diagram showing the configuration of a wireless communication system. A system 1 comprises a base station 2 and at least one terminal 3, base station 2 and terminal(s) 3 mutually transmitting and receiving data and control signals by wireless communication.

FIG. 2 is a diagram showing the configuration of base station 2. Base station 2 comprises an antenna 21, an RF part 22, a controller 23, a memory 24, and an interface part 25. Antenna 21 is used as a wireless signal transmitting and receiving interface with terminal 3. Signals received via antenna 21 are demodulated in RF part 22 and processed as received data in controller 23. In case terminal data are received from e.g. terminal 3, they are stored as the need arises in memory 24, after required processing has been carried out in controller 23. During transmission, controller 23 generates a signal to be transmitted which is modulated in RF part 22 and transmitted via antenna 21. Interface part 25 is used for connecting to a higher-level network 4.

FIG. 3 is a diagram showing an example of a configuration of a conventional terminal 3. In the present embodiment, an explanation will be given with a terminal used for a sensor net. Terminal 3 comprises an antenna 31, an RF part 32, a controller 33, a memory 34, a sensor 35, and a power supply 36. It is a terminal which has a function of communicating the data acquired with sensor 35 to base station 2. Antenna 31 and RF part 32 operate in the same way as antenna 21 and RF part 22 of base station 2. Controller 33 administers the control of RF part 32, memory 34, and sensor 35 and the information from sensor 35, and transmits data to base station 2 via RF part 32 and antenna 31. Further, in the case of receiving control signals, etc., from base station 2 via antenna 31 and RF part 32, it carries out various types of administration on the basis of control information. Memory 34 is provided for temporarily storing data acquired with sensor 35. Sensor 35 is provided for sensing information internal and external to the terminal. There is e.g. provided a temperature sensor which is used for a temperature monitoring system. Power supply part 36 supplies electricity to each block of terminal 3.

FIG. 4 is a diagram showing the details of the wireless part of a conventional terminal 3. RF part 32 has a function for modulating and transmitting data gradually sent from controller 33 and a function for demodulating a received signal coming from the terminal and communicating it to controller 33 and comprises a register 313 setting the operating parameters of these.

During transmission, data gradually sent from the controller are encoded in an encoder 301 and up-converted in a mixer 302. The local signal input into mixer 302 is generated by an oscillator 304. The output signal of mixer 302 is amplified in a power amplifier 303 to a power level required for transmission and transmitted via antenna 31. An antenna switch 305 is used for switching between transmission and reception circuits with respect to one antenna 31.

During reception, a signal which is input from antenna 31 is amplified in a low-noise amplifier 306 and mixed down in a mixer 307, and is converted to a baseband signal or an intermediate frequency (IF) signal. Subsequently, the received signal is selected in a band pass filter 308, amplified by means of an amplifier 309 to a signal amplitude level considered necessary in a demodulator 310, and input in demodulator 310. The input signal is demodulated as received data in demodulator 310 and communicated to controller 33 via an interface part 311. A carrier sense part 312 outputs the strength of the received signal.

As applications of the wireless communication system explained above, one can e.g. cite tracking and inventory management. As far as tracking and inventory management are concerned, the base station reading the data of the terminal can, as the need arises, be transferred to the vicinity or the like, not being limited to ordinarily being within the range of communication of the terminal. Rather, the opportunities for the terminal to be able to communicate with the base station are few, the result being a state wherein the base station is not present most of the time. Moreover, it is desirable that the base station, when it thinks it wants to read out the data of the terminal, is not made to wait but is capable of reading those data.

For battery-operated devices, as exemplified in terminals of wireless communication systems, reductions in the electric power consumption are important.

As an example, known in the art, of reducing the electric power consumption of a device by utilizing the carrier sensing of the signal of a specific channel, there is JP-A-2003-244057. As far as the system shown in JP-A-2003-244057 is concerned, it is basically used as a system for which it is assumed that a base station is present.

### SUMMARY OF THE INVENTION

In the aforementioned RF-ID or sensor net systems, in case a battery was used as the power supply of the terminal, an extension of the operating life of the terminal is important from the point of view of usefulness and operational cost reductions. In particular, in case the terminal is not used in a state where permanent communication with the base station is possible, there is a need for the terminal to continue standby operation, and the electric power consumption during this standby operation exerts a great influence on the operating life of the terminal. As operating modes of the terminal, a mode wherein the terminal is used continuouslyby means of exchanges of batteries and a throw-away mode can be considered, but for whichever of the modes, an extension of the lifetime of the terminal would contribute to a reduction in the operational costs.

Generally, in the case of comparing the monitoring of received signal demodulation and signal power, there is less power consumption during operation, and it is also possible to make the operating time shorter, when monitoring the signal power. Since the total electric energy consumption is the product of the electric power consumption during operation and the operating time, a reduction of the electric power consumption during operation as well as a shortening of the operating time are effective for the reduction of the total electric energy consumption.

Accordingly, in the present invention, the base station has available a beacon channel for alerting the terminal to its presence and a separate channel used for communication with the terminal. Here, a channel is something in which a signal for alerting the terminal to the presence of the base station and a signal used in the case of communication between the base station and the terminal are discriminated in at least one of a frequency domain, a time domain, and a code domain.

The terminal monitors the signal power of the frequency band of the beacon channel of the base station and, in case the signal power of that frequency band exceeds a predetermined prescribed value, considers the base station to be present, and performs operations for carrying out communication with the base station. In case the signal power of the received signal does not exceed the predetermined prescribed value, the terminal judges that no base station with which communication is possible is present and goes on standby for a prescribed time. In the following, the terminal reiterates signal strength monitoring and standby until it has judged the base station to be present. At this point, the standby time depends on the mode of utilization of the system, but it is preferable for the utilization method to make it as long as can be permitted.

In the case of configuring a wireless station, particularly in receiver systems, an electric power system separate from that of other circuits, like e.g. the digital circuits of a demodulation system, is made available and configured in such a way that noise of the digital systems does not penetrate, in order for the radio frequency front end part to be configured with analog circuits handling very minute electric power. Because of that, by choosing a configuration wherein the function of monitoring received signals is performed by a radio frequency analog front end part, the configuration of the power supply and the power supply control become simple if a power supply is supplied to the power supply system of the radio frequency front end part and the signal strength of the received signal can be measured.

In the case of comparing the monitoring of received signal demodulation and signal power, there is less power consumption during operation, and it is also possible to make the operating time shorter, when monitoring the signal power. Since the total electric energy consumption is the product of the electric power consumption during operation and the operating time, a reduction of the electric power consumption during operation as well as a shortening of the operating time are effective for the reduction of the total electric energy consumption. According to the present invention, it is possible, in a wireless communication system, to reduce the electric power consumption during the standby of a terminal, and it is possible to extend the operating life of a battery-operated terminal. Further, according to the present invention, the frequency of battery changes can be reduced, since the operating life of the terminal gets extended.

The terminal intermittently performs the operation of monitoring the power of signals transmitted by the base station and when it does not monitor signal power, an attainment of power savings is provided for by turning off the power supply of parts other than the control part for performing the intermittent operation.

While the terminal is monitoring only the signal power of signals transmitted by the base station, as for the wireless part in the terminal, an attainment of power savings is provided for by turning on the power only in those places which are needed for monitoring those signals.

According to the present invention, if a power supply is provided for the power supply system of the radio frequency analog front end part, the signal strength of a received signal can be measured, and power supply configuration and power supply control can be simplified.

Since the electric power consumption particularly in nearby wireless communications generally becomes larger the case of reception than in the case of transmission, the effect of reducing the electric power required for reception for carrier sensing is big.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a system configuration.

FIG. 2 is a diagram showing the configuration of a base station.

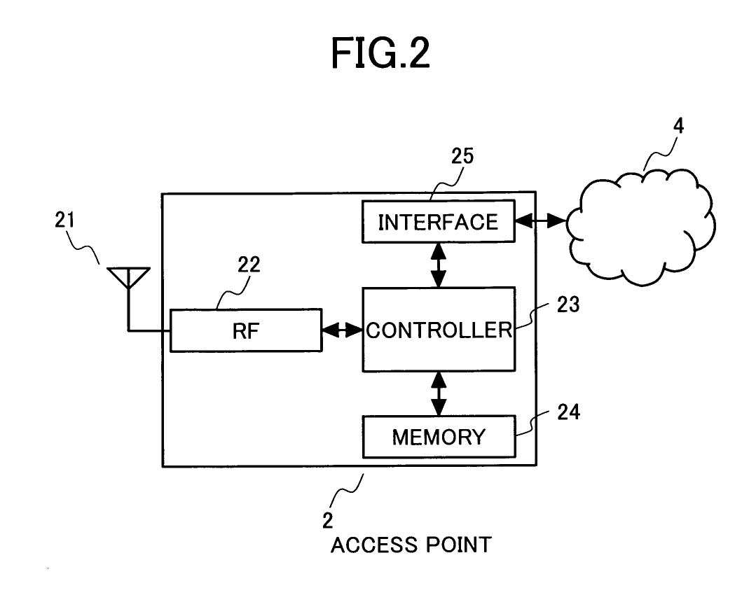

FIG. 3 is a diagram showing the configuration of a terminal.

FIG. 4 is a diagram showing the details of the wireless part of a conventional terminal.

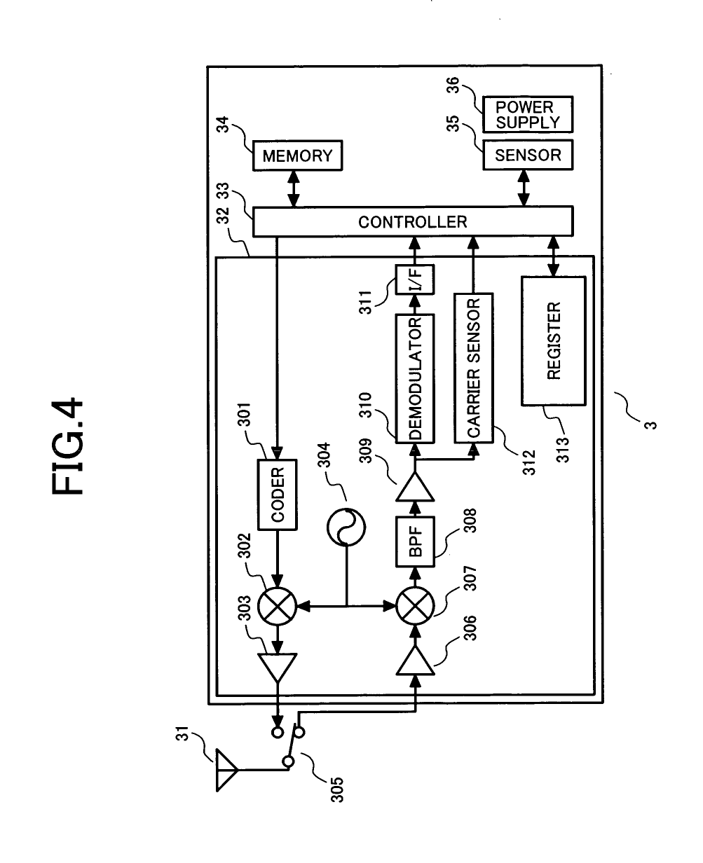

FIG. 5 is a diagram showing the details of the wireless part of a terminal according to the present invention.

FIG. 6 is a diagram showing the configuration of a base station according to the present invention.

FIG. 7 is a diagram showing an operating sequence of the base station.

FIG. 8 is a diagram showing an operating sequence of the terminal.

FIG. 9 is a diagram showing an example of a procedure for wireless communication between the base station and the terminal.

FIG. 10 is a diagram showing another example of an operating sequence of the terminal.

FIG. 11 is a diagram showing another example of a procedure for wireless communication between the base station and the terminal.

### DESCRIPTION OF THE EMBODIMENTS

### 1. First Embodiment

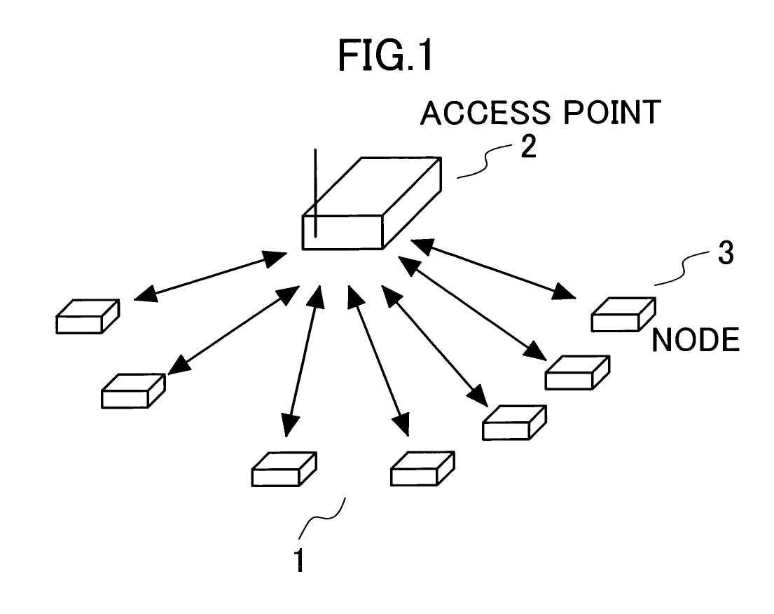

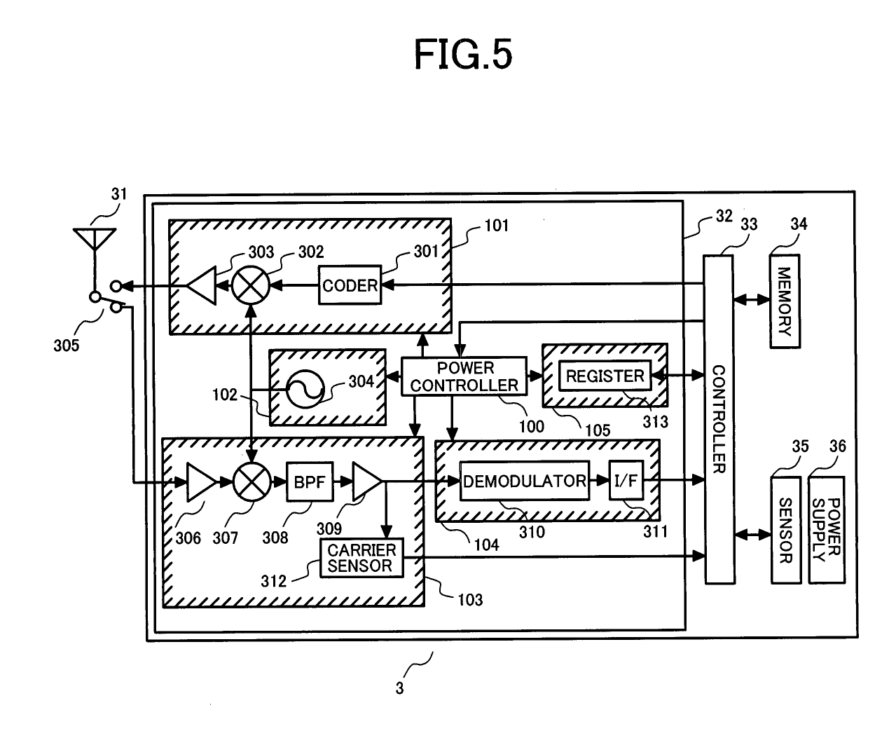

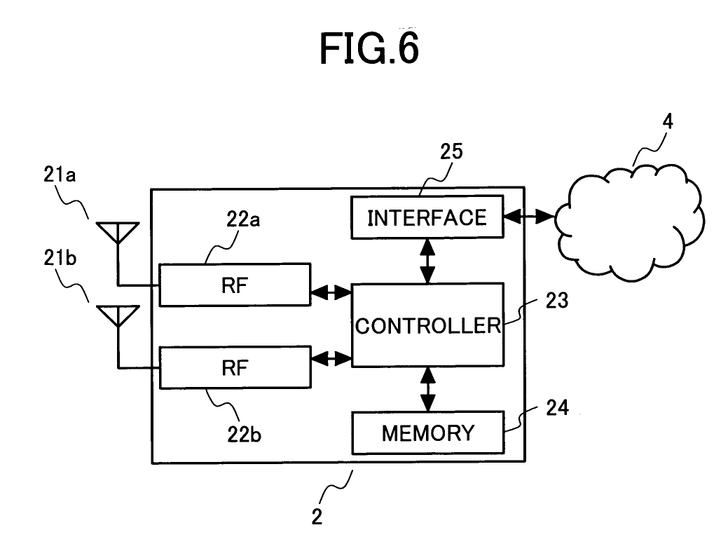

In the following, the embodiments of the present invention will be explained using the figures. The configuration of the whole system is similar to that in FIG. 1, and the configurations of the terminal and the base station are as shown in FIG. 5 and FIG. 6, respectively.

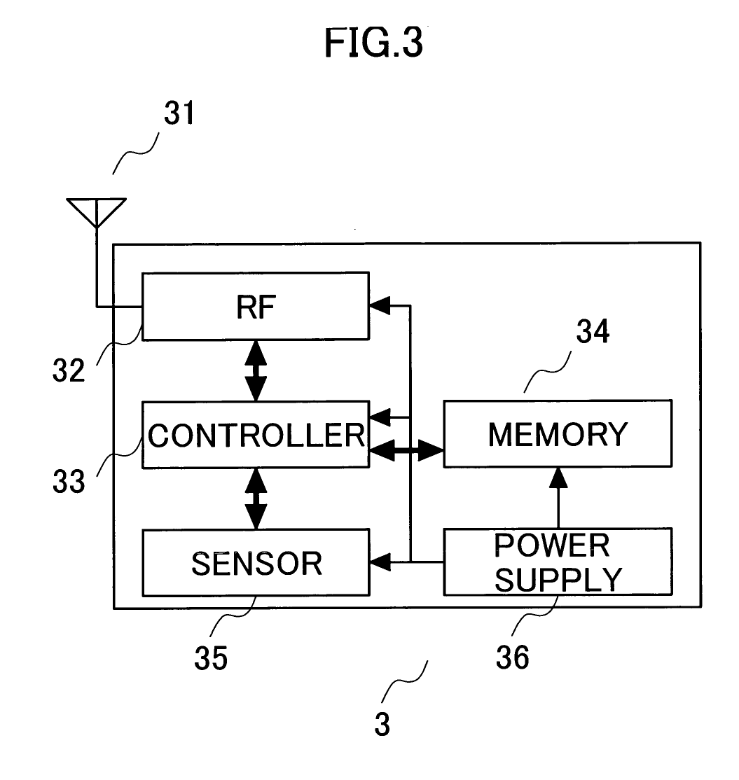

FIG. 5 is a diagram showing the details of the wireless part of a terminal according to the present invention. The operation of transmitting and receiving is similar to that of the terminal shown in FIG. 3. The points of difference are the points of providing a power supply management part 100 and dividing the internal parts of the wireless part into circuit blocks 101 to 105 so as to be able to switch the supply destinations of the power supply depending on the operating conditions. By providing a power supply only to those circuit blocks, from among circuit blocks 101 to 105, which are minimally required in the operation of transmission, reception, and carrier sensing, respectively, the wireless part is set up not to carry out unnecessary electric power consumption.

Here, carrier sensing means judging whether the base station transmitting the beacon is present in the communication range of the terminal, using the received power in the channel by which the beacon is transmitted.

Block 105 having a register has permanent electric power supplied while the wireless part is operating. During transmission, electric power is supplied to circuit blocks 101, 102, 105 and during reception, electric power is supplied to circuit blocks 102, 103, 104, 105. (If there is no need for transmitting an ACK (Acknowledgment) signal with respect to a received packet, there is no need to supply electric power to circuit block 101.)

Further, during carrier sensing, an electric power supply is provided to circuit blocks 102, 103, 105, and during reception, the supply of electric power to block 104, for which power supply was necessary in the conventional terminal, becomes unnecessary, so a cutback in the electric power consumption becomes possible.

Since it is possible to selectively pick out a specific channel in circuit block 103, if the received power of that channel is measured by circuit block 103 during carrier sensing, it is possible to confirm the presence of a base station with which communication is possible. There is no need to supply electric power to circuit block 104 carrying out demodulation and the like, so this portion of the power consumption can be cut back. Also, it is possible to cut back the portion of the power consumption corresponding to circuit block 101 for transmission. In a system where the time for performing carrier sensing is long compared to the time for performing actual data transmission and reception, even by just partially cutting back the power consumption of the wireless part, so the effect of extending the battery life is big.

Moreover, circuit block 103 is a reception part performing analog signal processing and circuit block 104 is a reception part performing digital signal processing. If a configuration is chosen wherein only circuit block 103 is operated and the received power is measured, without performing the signal processing of the digital system of circuit block 104, the power consumption can be reduced by cutting back the circuits supplying electric power and by being able to shorten the operating time.

Further, in the present embodiment, the signal of the post-stage of an amplifier 309 is input into a carrier sense part 312, but the same effect can be obtained e.g. by a method of inputting the output of a band pass filter 308 into carrier sense part 312 or a method of inputting the output of a low-noise amplifier 306 directly into carrier sense part 312. The method of inputting the signal of the post-stage of amplifier 309 into carrier sense part 312 and the method of inputting the output of a band pass filter 308 into carrier sense part 312 have higher carrier sensing accuracy, since the signal is input into carrier sense part 312 after filtering out other, unnecessary signals. Moreover, as for the method of inputting the output of a low-noise amplifier 306 directly into carrier sense part 312, it is not necessary to bring an oscillator 304, a mixer 307, and a BPF (Band Pass Filter) 308 into operation, so an attainment of power savings can be provided for by blocking the power supply of the concerned blocks.

FIG. 6 is a diagram showing the configuration of a base station 2 according to the present invention. It has respective multiple antennas 21 and multiple wireless parts 22. Base station 2 has two channels available, a beacon channel and a communication channel, and shows an embodiment using different frequencies as different channels. In the present embodiment, a configuration example is shown in which multiple antennas and wireless parts are provided. This shows the configuration for the case where different frequencies are allocated and used for the respective channels. E.g., the beacon channel uses antenna 21a and wireless part 22a and the communication channel uses antenna 21b and wireless part 22b. It is acceptable to use an antenna in common and to use a splitter to make connections to multiple wireless parts.

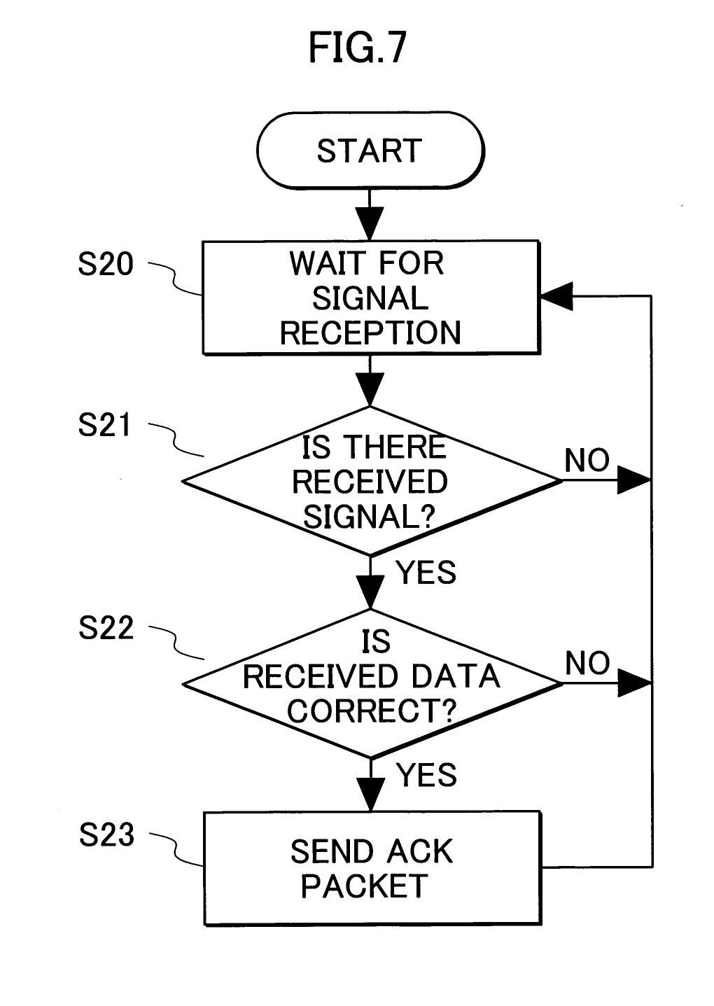

FIG. 7 is a diagram showing the operating sequence of base station 2. After activating the power supply, the base station, using wireless part 22a and antenna 21a, continuously outputs a signal for alerting terminal 3 to its presence on the beacon channel (CH1). Moreover, the communication channel (CH2) using wireless part 22b and antenna 21b enters a reception waiting state (S20) to wait for the reception of a data packet from terminal 3. In case there is a received packet from terminal 3 (S21), it is determined whether it was possible to receive those received data without error and correctly (S22). In case it was not possible to receive the data correctly, the received data are destroyed and the reception waiting state is entered again (S20). Also, in case it was possible to receive the data correctly, an Acknowledgement (ACK) packet is transmitted toward the transmission source terminal (S23), and so forth, to carry out normal reception processing.

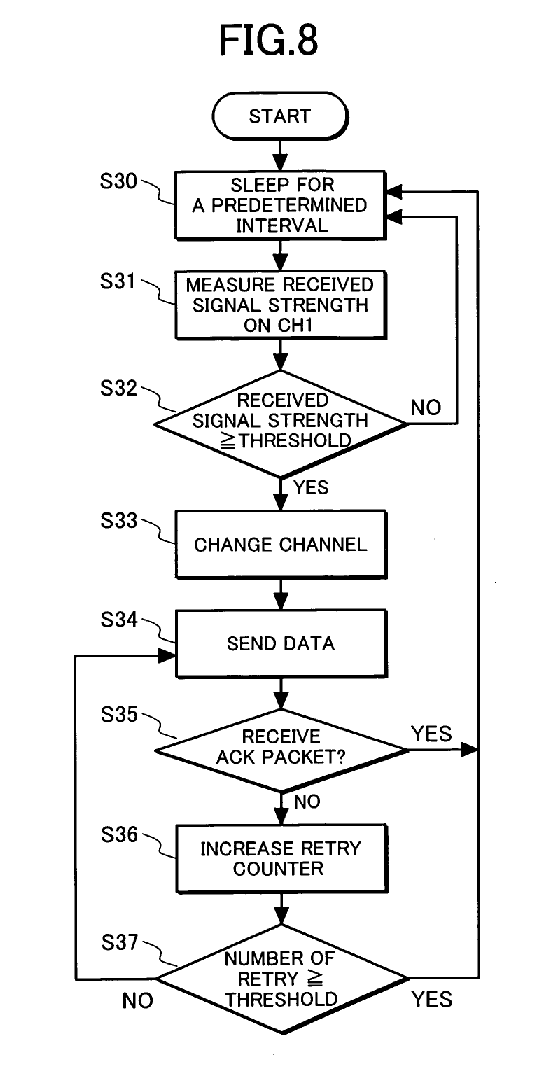

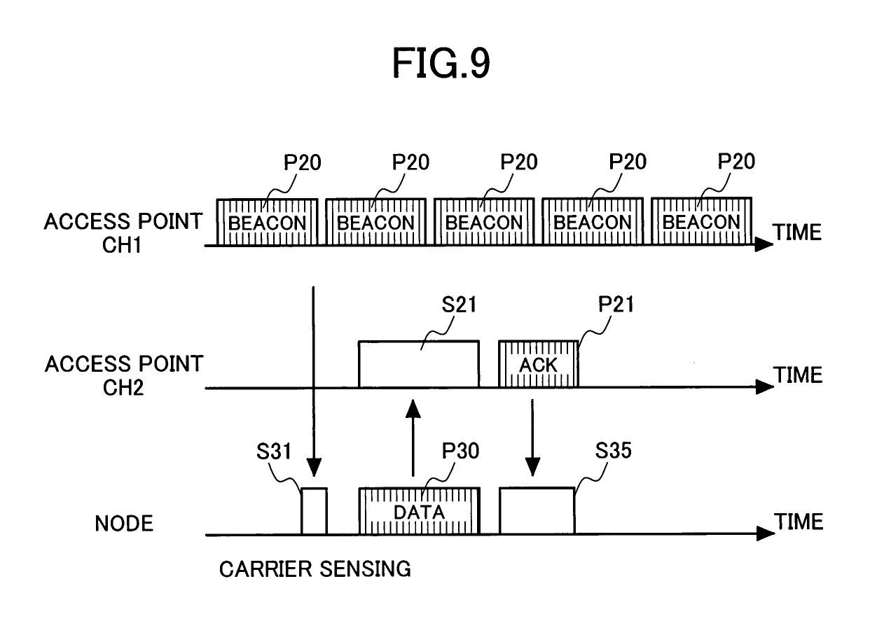

FIG. 8 is a diagram showing the operating sequence of terminal 3. FIG. 9 is a diagram showing an example of a procedure for wireless communication between a base station and a terminal. After activating the power supply, terminal 3 stands by during a fixed time interval (S30) and performs carrier sensing in the beacon channel (CHl). Specifically, power supply is provided to circuit blocks 102, 103, 105, and the signal strength of the received signal is measured in carrier sense part 312 (S31). The relative magnitudes of the signal strength of the received signal and a predetermined value are compared (S32). If, as a result of the comparison, the signal strength of the received signal is less than a threshold value, it is judged that there is no beacon and consequently that base station 2 is not present, and there is a transfer to the standby state (S30). If the signal strength of the received signal is greater than the threshold value, it is judged that base station 2 is present, power supply is provided at least to circuit blocks 101, 102, 105, the used channel is switched to the communication channel (S33), and a data packet (P30) is transmitted (S34). After transmission of the data packet (P30), power supply is provided to circuit blocks 102, 103, 104, 105, and an ACK packet (P21) reception waiting state is entered (S35). In case it was not possible to receive an ACK packet (P21) even while waiting for the fixed time interval in the ACK packet (P21) reception waiting state (S35), the retransmission number is incremented (S36), and if it is within a prescribed number (S37), retransmission of the same data is attempted. In the case of receiving an ACK packet from the base station, the data transmission is considered to have reached completion, the retransmission counter is cleared and the standby state (S30) is entered again.

### 2. Second Embodiment

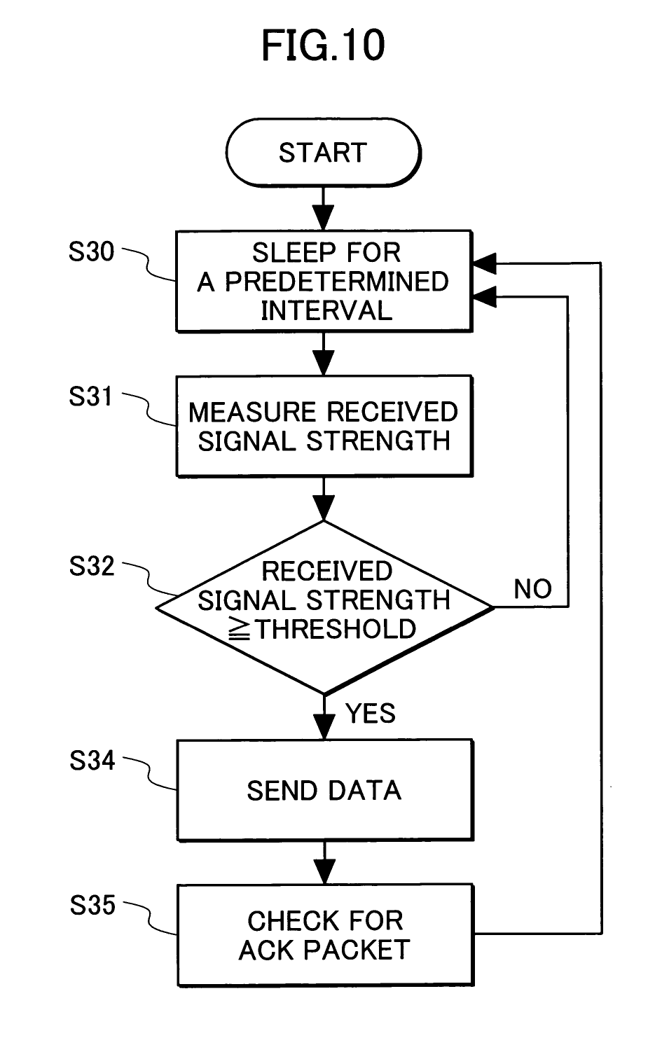

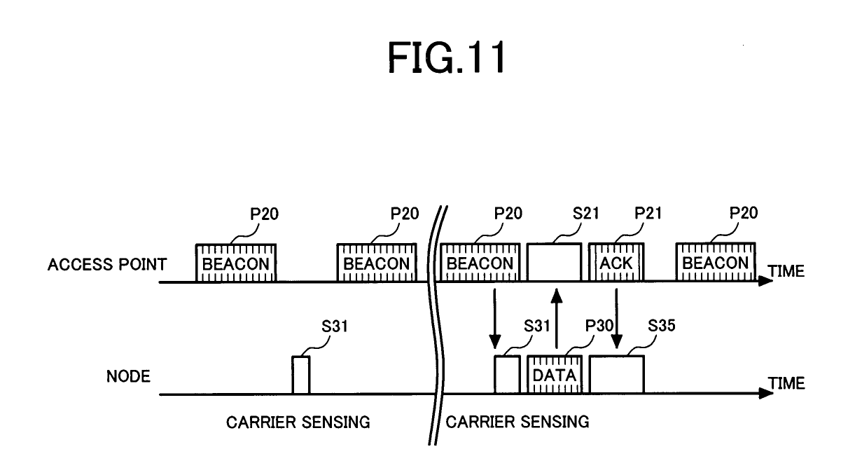

In the following, an explanation will be given, using the drawings, of another embodiment of the present invention. FIG. 10 is a diagram showing another example of an operating sequence of the terminal. FIG. 11 is a diagram showing another example of a procedure for wireless communication between a base station and a terminal. It is considered that one frequency is used in the present embodiment, base station 2 transmits the beacon signal periodically (P20), and that terminal 3 performs carrier sensing of the beacon signal (P20) of base station 2 and measures the signal strength of the received signal.

By taking the beacon signal (P20) transmitted by base station 2 and the timing of the carrier sensing of terminal 3 to have different periods, it is possible to capture the beacon signal (P20) of the base station by performing carrier sensing a number of times, in case base station 2 is present in the range within which communication with terminal 3 is possible. Alternatively, the time of continuously performing carrier sensing may be made longer than the time intervals between transmissions of the beacon signal. In the subsequent operation, with the same method as in Embodiment 1, terminal 3 transmits a data packet (P30) and base station 2 transmits an ACK packet (P21). According to this embodiment, there is no need for the base station and the terminal to switch frequency channels for carrier sensing and for data communication.

It should be further understood by those skilled in the art that although the foregoing description has been made on embodiments of the invention, the invention is not limited thereto and various changes and modifications may be made without departing from the spirit of the invention and the scope of the appended claims.

1. A wireless communication system comprising a base station and at least one terminal, characterized in that
said base station is provided with a function of transmitting a wireless signal aimed at alerting
said terminal to its presence, said terminal performs reception with a communication channel for a signal alerting to the presence of said base station and is provided with a function of measuring the electric power of the received signal of said communication channel, and
said base station is present within the communication range of said terminal in case the measured result of the received power is greater than a prescribed value.

2. A wireless communication system according to claim 1, characterized in that
said base station uses a first carrier wave frequency for the communication channel for transmitting a wireless signal aimed at alerting the terminal to its presence and uses a second carrier wave frequency, different from the first carrier wave frequency, for a separate communication channel used for communication with said terminal, and
said terminal measures the received power of the signal alerting to the presence of said base station at said first carrier wave frequency and communicates with the base station using the second carrier wave frequency in case the received power measurement result is greater than a prescribed value.

3. A wireless communication system according to claim 1, characterized in that said base station transmits a wireless signal aimed at alerting the terminal to its presence at a prescribed first period, said terminal measures the received power of the signal alerting to the presence of said base station at a prescribed second period, and the multiples of said first period are different from said second period.

4. A wireless communication system according to claim 1, characterized in that
said terminal, in case said terminal measures the received power of a signal alerting to the presence of said base station, has a low-noise amplifier, a down-converter mixer, and a filter, amplifies the signal received by said terminal with said low-noise amplifier, converts it with said down-converter mixer to an intermediate frequency, filters it with said filter, and measures the magnitude of the output signal of said filtering.

5. A wireless communication system according to claim 1, characterized in that
said terminal, in case said terminal measures the received power of a signal alerting to the presence of said base station, has a low-noise amplifier and measures the magnitude of the output of said low-noise amplifier.

6. A terminal in a wireless communication system comprising a base station and at least one terminal, characterized by
having a first receiver part detecting a prescribed communication channel, a second receiver part performing signal processing of the received signal in said detected prescribed communication channel, and a power supply part providing electric power selectively to said first and second receiver parts, and in that,
in order for said terminal to judge whether a base station is present within its communication range,
said power supply part provides electric power to said first receiver part, and
said first receiver part detects said prescribed communication channel over which is transmitted a wireless signal, transmitted from said base station, for alerting to the presence of said base station, measures the received electric power in said communication channel, and determines whether the base station is present within the communication range of the terminal, on the basis of said received electric power.

7. A terminal according to claim 6, characterized in that, when said terminal judges whether a base station is present within its communication range, said power supply part does not provide electric power to said second receiver part.

8. A terminal according to claim 6, characterized in that said second receiver part has a demodulator demodulating at least the signal received by said first receiver part.

9. A terminal according to claim 6, characterized in that said first receiver part is a receiver part including analog circuits and said second receiver part is a receiver part including digital circuits.

10. A terminal according to claim 6, characterized in that the prescribed communication channel transmitting the wireless signal for alerting to the presence of said base station is a communication channel defined by a carrier wave frequency.

11. A base station detection method in a terminal for a wireless communication system comprising a base station and at least one terminal, characterized in that
said terminal has a first receiver part detecting a prescribed communication channel, a second receiver part performing signal processing of the received signal in said detected prescribed communication channel, and a power supply part providing electric power selectively to said first and second receiver parts, and in that,
in order for said terminal to judge whether a base station is present within its communication range,
said power supply part provides electric power to said first receiver part, and in that,
in said first receiver part, there is detected said prescribed communication channel over which is transmitted a wireless signal, transmitted from said base station, for alerting to the presence of said base station, there is measured the received electric power in said communication channel, and there is determined whether the base station is present within the communication range of the terminal, on the basis of said received electric power.

12. A base station detection method according to claim 11, characterized in that, when said terminal judges whether a base station is present within its communication range, said power supply part does not provide electric power to said second receiver part.

13. A base station detection method according to claim 11, characterized in that said second receiver part is a receiver part having a demodulator demodulating at least the signal received by said first receiver part.

14. A base station detection method according to claim 11, characterized in that said first receiver part is a receiver part including analog circuits and said second receiver part is a receiver part including digital circuits.

15. A base station detection method according to claim 11, characterized in that the prescribed communication channel transmitting the wireless signal for alerting to the presence of said base station is a communication channel defined by a carrier frequency.
